(19) United States
(12) Patent Application Publication
(10) Pub. No.: US 2025/0033238 A1
(43) Pub. Date: Jan. 30, 2025

(54) LUMBER TREATMENT SYSTEM

(71) Applicant: Jerome Anthony Huber, JR., Cambridge, IA (US)

(72) Inventor: Jerome Anthony Huber, JR., Cambridge, IA (US)

(21) Appl. No.: 18/360,439

(22) Filed: Jul. 27, 2023

(51) Int. Cl. B27K 5/02

(52) U.S. Cl. CPC B27K 5/02

(57) ABSTRACT

A system for treating a rectangular workpiece, the system provides a conveyor extending along a longitudinal direction, wherein the conveyor enables movement of the rectangular workpiece being restrained in a latitudinal direction. Along the conveyor is a sequential arrangement of a first pair of side brushes, a top brush, and a bottom brush, wherein each brush is adjustably fixed relative to the conveyor. The location in space, relative to the conveyor, of a distal edge of each brush defines a planing surface that is adapted to level a fluid treatment previously applied along each surface of the rectangular workpiece.

### BACKGROUND OF THE INVENTION

The present invention relates to lumber treatment systems and, more particularly, to a device for rending a uniform treatment to lumber by planing the treatment previously applied along a surface of the lumber.

Sealing and staining of wood deck and fences are frequently done post installation of the project, wherein such applications involve spraying of the stain directly on the installed wood. As a result, not all the surface area would be sealed and protected due to the installation process.

Current board-staining systems first apply stains to paint rollers for the stain application. After multiple applications, the rollers will flatten their shape and dry out, causing missed areas for subsequent boards. Specifically, when applying stain directly by way of a paint roller, the paint roller must be fully saturated prior to applying the stain throughout multiple rotations, because a non-saturated state results in an inconsistent staining of the board.

These machines also use moving parts, or adjustable parts which modify the stain process through their movement or adjustments, resulting in a loss of consistent pressure against the board for the stain application. For instance, current devices that use spring loaded arms to hold the paint rollers do not allow for consistent pressure to uniformly release the stain from the paint rollers onto the board, again causing inconsistent staining to the board.

Also, by using disposable parts, such as paint rollers, current board-staining systems are not a long-term solution to a machine designed to stain thousands of boards. Especially because changing horses midstream, so to speak, can lead to inconsistent applications of stain and possibly resulting in aesthetically unpleasant stain color changes.

Furthermore, current devices also do not account for the removal of excess saw dust from the lumber. Moreover, replacement parts are expensive.

As can be seen, there is a need for a device, system, and method for rendering uniform treatment to lumber.

### SUMMARY OF THE INVENTION

The present invention enables lumber to be stained prior to fence and or deck installation, thereby ensuring that all surface areas of the lumber are sealed and stained prior to installation of the project.

The present invention applies the stain directly to the board. Then, the stain is leveled and spread evenly across the board by back brushes. By using back brushes instead of paint rollers these brushes are easily removed, quickly cleaned with mineral spirits, and re-installed, thereby the same brushes can be used over and over with multiple colors of stain, for ensuring consistent application of the stain. In other words, there are no disposable or adjustable parts that invite inconsistencies upon replacement.

The present invention allows the user to manually push the lumber through the machine, selectively enabling even and consistent application the stain to all surface areas, whereby saturation and uniform saturation of the lumber is the result of the board's interaction, under the user's manual control, with immobile components of the inventive process.

The present invention enables a uniform application of treatment to lumber through a removal of excess methodology, whereby the lumber is urged pass fixed brushes that ensure uniform application by removal of excess treatment.

In one aspect of the present invention, system for treating a rectangular workpiece, the system includes: a conveyor extending along a longitudinal direction, wherein the conveyor enables movement of the rectangular workpiece being restrained in a latitudinal direction; and a first pair of side brushes, a top brush, and a bottom brush sequentially disposed along the conveyor, wherein each said brush is adjustably fixed relative to the conveyor so as to level a fluid treatment applied along each surface of the rectangular workpiece.

In another aspect of the present invention, the above system further includes wherein the latitudinal direction is orthogonal relative to the longitudinal direction; a second pair of side brushes disposed along the conveyor aft the bottom brush, wherein the fluid treatment is applied along each surface of the rectangular workpiece by way of a spray zone disposed along the conveyor fore the first pair of side brushes, wherein the spray zone is defined, in part, by a plurality of application conduits; further including a pair of guides fore the first pair of side brushes, wherein the pair of guides are adjustable fixed relative to the conveyor so as to restrain the rectangular workpiece passing between the pair of guides, wherein a lateral gap defined between the pair of guides is approximately equal to a lateral gap defined between the first pair of side brushes; and further including a pair of dust brushes disposed along the conveyor for the first pair of side brushes.

In yet another aspect of the present invention, a device for treating a rectangular workpiece, the device includes the following: a conveyor extending along a longitudinal direction, wherein the conveyor enables movement of the rectangular workpiece being restrained in a latitudinal direction; a pair of dust brushes, a first pair of side brushes, a top brush, a bottom brush, and a second pair of side brushes sequentially disposed along the conveyor, wherein each said brush is adjustably fixed relative to the conveyor so as to level a fluid treatment applied along each surface of the rectangular workpiece, wherein the fluid treatment is applied along each surface of the rectangular workpiece by way of a spray zone disposed along the conveyor between the pair of dust brushes and the first pair of side brushes, wherein the spray zone is defined, in part, by a plurality of application conduits; and a pair of guides fore the first pair of side brushes, wherein the pair of guides are adjustable fixed relative to the conveyor so as to restrain the rectangular workpiece passing between the pair of guides, wherein a lateral gap defined between the pair of guides is approximately equal to a lateral gap defined between the first pair of side brushes.

These and other features, aspects and advantages of the present invention will become better understood with reference to the following drawings, description and claims.

### BRIEF DESCRIPTION OF THE DRAWINGS

FIG. 1 is a side perspective view of an exemplary embodiment of the present invention.

FIG. 2 is a top perspective view of an exemplary embodiment of the present invention.

FIG. 3 is a detailed perspective view of an exemplary embodiment of the present invention.

FIG. 4 is a top plan view of an exemplary embodiment of the present invention.

FIG. 5 is a detailed top plan view of an exemplary embodiment of the present invention, indicated by line 5-5 of FIG. 4.

FIG. 6 is a top perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system for treating a rectangular workpiece, the system provides a conveyor extending along a longitudinal direction, wherein the conveyor enables movement of the rectangular workpiece being restrained in a latitudinal direction. Along the conveyor is a sequential arrangement of a first pair of side brushes, a top brush, and a bottom brush, wherein each brush is adjustably fixed relative to the conveyor. The location in space, relative to the conveyor, of a distal edge of each brush defines a planing surface that is adapted to level a fluid treatment previously applied along each surface of the rectangular workpiece.

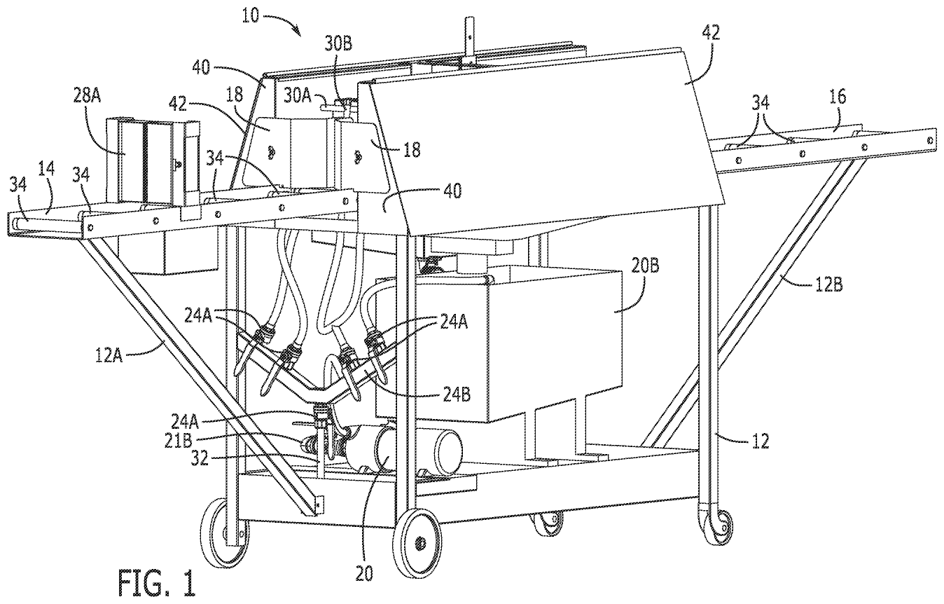

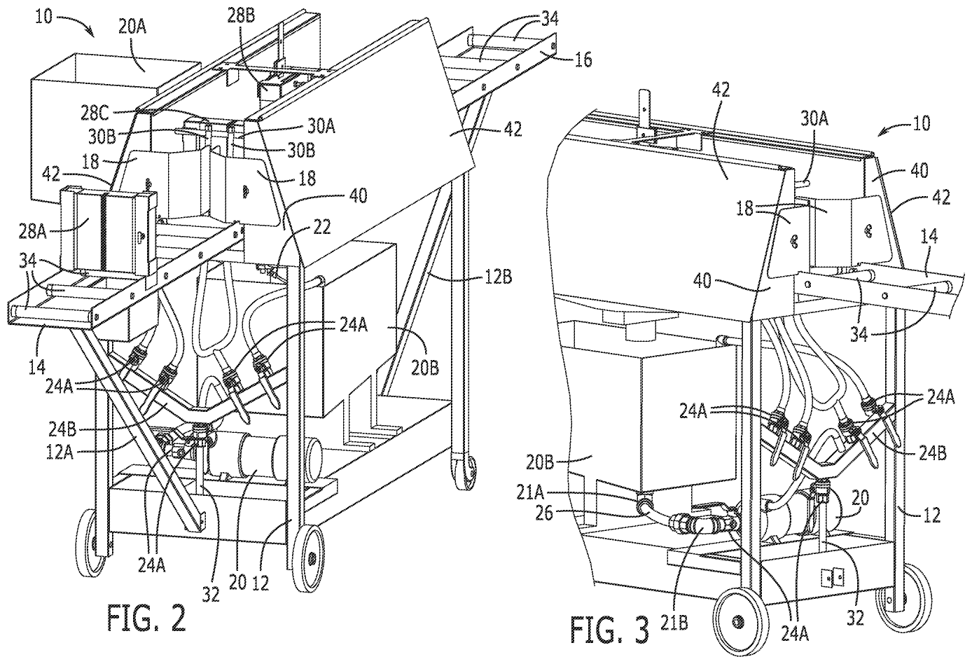

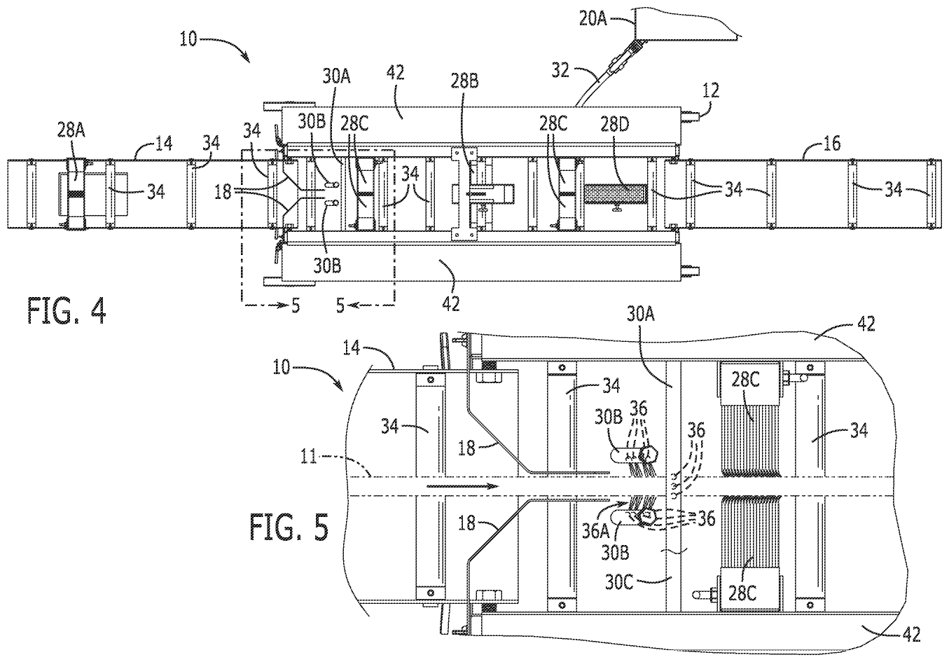

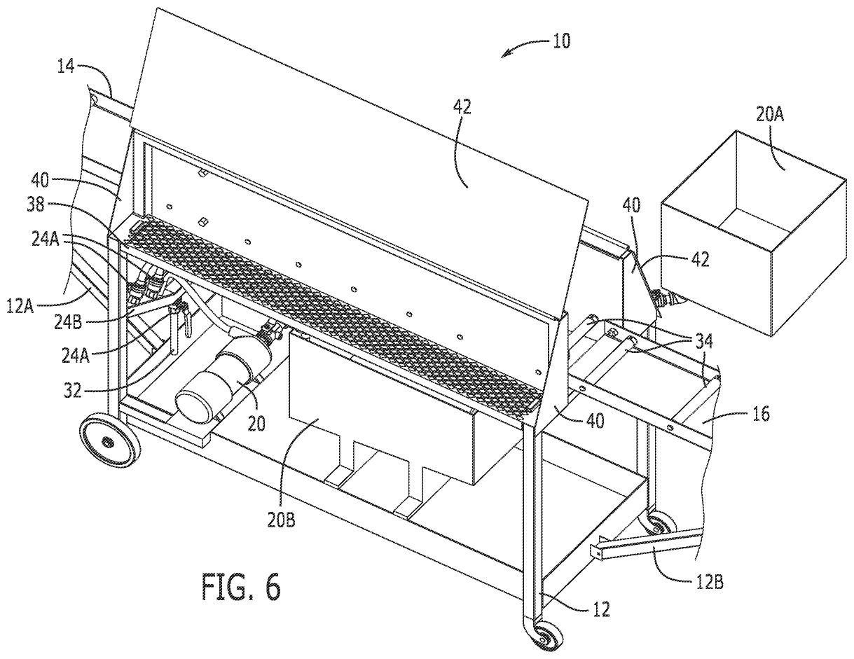

Referring to FIGS. 1 through 6, the present invention may include a device for applying uniform treatment to lumber, wherein the device may have the following constituent components: a plurality of ball valves (for the return line, for the treatment application conduits, and for the drain manifold); a plurality of supply lines (including braided tubing) for draining, a supply line 32 for treatment fluid to a manifold, etc., a drive pump 20; male hose brass barbs (including tees and male pipe); a hose clamp; a 90-degree male hose brass elbow 21A; a female brass adapter, close galvanized pipes; 90-degree galvanized elbows 21B; a brass barb MP; galvanized unions; one or more hose clamps; vertical application conduits 30B with holes or nozzles 36 to apply a spray 36 of treatment fluid (e.g., stain); one or more horizontal application conduits 30A and 30C with holes or nozzles 36; an internal steel shaft; one or more a brass female pipe caps; a shaft collar with set screw; a rubber roller tube; an internal steel shaft; a shaft collar with set screw; a rubber roller tube; dust remover brushes 28A, each with a dust brush holder, and a thumb screw; a long dust collection box; an internal steel shaft; a shaft collar w/set screw; a rubber roller tube; shoulder bolts; back brushes with H-back brush holder with thumb screws; a top brush holder support bracket; a self-drill tap screw; a primary tank 20A (with drainage); left and right adjustable board guides 18 providing wing nuts and slots or other acceptable adjustable fasteners for adjustment of the board guides 18; a ball valve manifold 24B to direct stain; an offset wheel; a flat washer; a nylon insert lock nut; a hex head bolt; gray stem caster wheels; long roller trays 16; adjustable support arms 12A; a front support arm holder; a clevis pin w/cotter key; a catch basin tray; a motor mount platform; a secondary tank support; and square conduits. It being understood that different material types, fastener types, shapes and dimensions of the constituent components disclosed herein may be used as long as the present invention functions as disclosed herein.

The lumber treatment device 10 applies sprayable treatments to individual lumber 11. The sprayable treatment 36A may be an oil-based stain that is poured into a primary tank 20A of the lumber treatment device 10. The fluid treatment is gravity fed into a secondary tank 20B, where the volume is controlled by a float valve 22 and then may be gravity fed into a pump 20 to prime and applied by way of continuous machine operation. The pump 20 is powered to move the fluid treatment into the ball valve manifold 24B which directly pumps the fluid treatment to the vertical and horizontal application conduits 30A, 30B, 30C that will apply the fluid treatment, by way of a spray 36A, directly to the lumber 11. Ball valves 24A on the manifold 24B manage and control the amount of fluid treatment that is applied through the vertical and horizontal application conduits 30A, 30B, 30C. The ball valves to the return line can selectively restrict or increase fluid treatment flow to the vertical or horizontal application conduits 30A, 30B, 30C and will also allow the fluid treatment to bypass to the secondary tank 20B.

After application of treatment spray 36A, excess fluid treatment is urged off the surface of the lumber 11 by brushes 28B, 28C, 28D, in a manner that leaves a uniform application of the fluid treatment along the surface of the lumber 11. Overflow of the excess fluid treatment removed by the brushes 28B, 28C, 28D flows down to the catch basin so that the fluid treatment can be recycled through the secondary tank 20B.

The lumber 11 is manually pushed, initially, through the dust brushes 28A to remove excess sawdust particles, and then through a spray zone defined in part by the vertical and horizontal application conduits 30A, 30B, 30C that apply the fluid treatment in spray form 36A directly to all sides of the lumber 11. During this process that the fluid treatment is applied, downstream excess fluid treatment applied to the lumber 11 is levelled and spread uniformly by the first set of fixed vertical brushes 28C. The top horizontal brush 28B removes the excess fluid treatment from the top of the lumber 11 letting it fall down the side of the lumber 11 to assist in additional staining that will be leveled and spread by the second set of vertical brushes 28C. The horizontal brush 28D on the bottom removes excess stain from the bottom of lumber 11 as the lumber 11 is manually pushed through the machine. All while the fluid treatment is constantly being urged through the system by the pump 20 in a closed loop machine system.

A method of making the present invention may include the following. The lumber treatment device 10 has a framework 12 that includes of right frame, and left frame, which supports the catch basin, right side brush drying catch basin 38, right side expanded metal brush drying platform, left side brush drying catch basin, left side expanded metal brush drying platform, right side wall of tunnel, left side wall of tunnel, and bottom floor of tunnel, main box drain, secondary drain, front offset wheel assembly with stem caster wheel.

The exterior of the main upper body assembly may include a right door 42, right door piano hinge, left door 42, left door piano hinge, left front frame cover 40, right front frame cover 40, right rear frame cover 40, left rear frame cover 40.

The internal tunnel tray may include a bottom floor tunnel, right side wall of tunnel, left side wall of tunnel, right vertical application and left vertical application conduits 30B, top horizontal application conduit 30A, bottom horizontal application conduit 30C, a plurality of internal steel shafts and shaft collars with set screw, a plurality of rubber rollers 34, left front back brush holder, left back brush, right front back brush holder, right front back brush, top back brush holder, top back brush, top brush holder support bracket, left rear back brush holder, left rear back brush, right rear back brush holder, right rear back brush, bottom rear back brush holder, and bottom rear back brush.

Attached to the machine framework may be the front roller tray attached with shoulder bolts. The front roller tray is supported with the adjustable support arms 12A, 12B secured into the front support arm holder with a clevis pin and a cotter key. Adjustable lumber guides 18 may be placed along the conveyor belt just before (upstream) of the spray zone. The lumber guides 18 define a location of the periphery of the lumber 11 when it passes through the spray zone and against the brushes 28B, 28C, 28D.

Additions to enhance the member treatment device 10 may include automated feed rollers on the entrance and/or exit trays to control the speed of the elongated member 11. This will address the manual process of moving the elongated member 11 through the machine 10 at unpredictable rates of speed.

Another additional feature to be added to the member treatment device 10 could be a drop tray for the boards to fall onto after they are stained and move off the automated feed roller 34. This would assist in stacking multiple elongated member 11 instead of removing one board at a time. The components used can be interchanged with different sizes or product materials.

The present invention could be used by fence companies, deck companies, landscape companies, builders, DIY's (do it yourselfers) to stain boards prior to any installation of wood, e.g., 1×6 and 2×4 boards. This step allows the stain to be applied to all areas of the board prior to installation allowing for longer life of the board due to the consistency to defend against weather elements. If stain is applied post installation without the present invention, many areas of the board are not maintained or covered by stain due to installation procedures. p

A method of using the present invention may include priming the magnetic drive pump 20 by pouring oil-based stain into the primary tank 20A which will flow through a conduit (e.g., a ½″ braided tubing) through the float valve 22 which will fill the secondary tank 20B. From the secondary tank 20B, the stain will flow through the conduit and the stain will go through a braided hose to prime the pump. Now the machine is ready to be plugged into a 110v electrical outlet.

Now that the pump is primed a user is ready to apply the oil-based stain to a wood member by the machine pump pumping stain into the ball valve manifold 24B, which will then pump stain into ball valve 24A which will then pump stain through braided conduit 26 back into the secondary tank 20B. Then through ball valve 26 and into braided conduit 26 which will flow into the vertical application conduits 30B. Stain will pump through ball valve 24A into top horizontal application conduit 30A and pump through ball valve 24A into a fluid conduit and into lower horizontal application conduit 30C. The stain will constantly move through the machine in a closed loop system to allow continual staining of additional boards. Now the user may take an elongated member 11 (e.g., 1×6 or 2×4, 2×6) and place the elongated member 11 on entrance tray 14 and manually push the elongated member 11 through the dust brushes 28A to remove sawdust particles and through the adjustable guides 18. As the elongated member 11 proceeds stain will be applied to the elongated member 11 via the vertical application conduits 30B and upper horizontal application conduit 30A and bottom horizontal application conduit 30C. After the stain is applied to the elongated member 11 and still being manually pushed through the machine, the stain is leveled and spread further onto the elongated member 11 by brushes, 28C. Stain is also further spread and leveled by top brush 28B. The elongated member 11 will manually move through an additional set of brushes 28C to level and spread the sides of the board as well as the bottom bush 28D to spread the stain. From this point the elongated member 11 will manually exit the rear roller tray 16.

During use, the workpiece 11 is first placed on the entrance tray 14. The entrance tray 14 has a series of rollers 34, thereby defining a conveyor belt extending from the entrance tray 14 to the rearward exit tray 16. The workpiece 11 rides along the rollers 34/conveyor belt under the manually urging of an operator. It is understood that the present invention contemplates a fully autonomous or continuous embodiment where a motor drives the workpiece through the inventive process.

Along the conveyor belt, the workpiece 11 first encounters two opposing dust brushes 28A that knocks any debris off the surfaces of the workpiece 11. Then, upon continued urging of the operator, the distal end of the workpiece 11 contacts the opposing guide plates 18 which funnel the workpiece 11 to a specific position along the conveyor belt, laterally restraining the workpiece 11. In other words, the lateral/latitudinal positioning (in the x-direction) of the workpieces 11 is restrained as it moves longitudinally (in the y-direction) along the conveyor belt. This is done by spacing apart the two guides 18 so as to rigidly define a lateral gap therebetween.

After the dust brushes 28A, the restrained cross-section of the workpiece 11 moves into a spray zone, shown in FIG. 5, where all four surfaces of the restrained cross-section have fluid treatment applied via the treatment application conduits 30A, 30B, 30C. The fluid application may be by way of treatment spray 36A urged through the holes or nozzles 36 of the treatment application conduits 30A, 30B, 30C under the pressure of the pump 20.

After the spray zone, the workpiece 11 engages a first pair of opposing side brushes 28C disposed along the conveyor belt. The x-axis location of the two opposing side brushes 28C is adjustably fixable so that the two side brushes 28C define a lateral gap with a selected lateral distance. As the retained cross-section of the workpiece 11 passes through the lateral gap the distal ends of the bristles of each of the two side brushes 28C level the fluid treatment along the lateral sides of the workpiece in a uniform manner. This process, conceptually, “planes” of “surfaces” the applied treatment to a uniform thickness along the outer surface of the lateral sides of the workpiece. This “surfacing” or removal of excess fluid treatment through a preselected lateral gap defined by the two side brushes 28C (which is defined in conjunction with the cross-section of the workpiece 11—i.e., the actual lumber dimensions, as well as the lateral gap between the two guides 18 as mentioned above). Excess fluid treatment is essentially brushed off and is returned to the closed loop system by way of the catch basin or secondary tank 20B.

After the first set of side brushes 28C, then a top brush 28B similarly defines a resulting “planed” uniform, level thickness of treatment along an upper surface of the workpiece 11 by way of established a fixed upper boundary that “planes” the thickness of the fluid treatment along the upper surface of the workpiece 11.

Spaced apart from the top brush 28B is a bottom brush 28D that similarly “planes” the applied treatment along the lower surface of the workpiece 11.

Finally, a second set of opposing side brushes 28C is disposed along the conveyor belt to reestablish a level treatment along the sides of the workpiece 11 that may have been modified by the top and bottom brushes 28B, 28D “treatment planning”.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A system for treating a rectangular workpiece, the system comprising:
a conveyor extending along a longitudinal direction, wherein the conveyor enables movement of the rectangular workpiece being restrained in a latitudinal direction; and
a first pair of side brushes, a top brush, and a bottom brush sequentially disposed along the conveyor, wherein each said brush is adjustably fixed relative to the conveyor so as to level a fluid treatment applied along each surface of the rectangular workpiece.

2. The system of claim 1, wherein the latitudinal direction is orthogonal relative to the longitudinal direction.

3. The system of claim 1, further comprising a second pair of side brushes disposed along the conveyor aft the bottom brush.

4. The system of claim 1, wherein the fluid treatment is applied along each surface of the rectangular workpiece by way of a spray zone disposed along the conveyor fore the first pair of side brushes.

5. The system of claim 4, wherein the spray zone is defined, in part, by a plurality of application conduits.

6. The system of claim 1, further comprising a pair of guides fore the first pair of side brushes, wherein the pair of guides are adjustable fixed relative to the conveyor so as to restrain the rectangular workpiece passing between the pair of guides.

7. The system of claim 6, wherein a lateral gap defined between the pair of guides is approximately equal to a lateral gap defined between the first pair of side brushes.

8. The system of claim 3, further comprising a pair of dust brushes disposed along the conveyor for the first pair of side brushes.

9. A device for treating a rectangular workpiece, the device comprising:
a conveyor extending along a longitudinal direction, wherein the conveyor enables movement of the rectangular workpiece being restrained in a latitudinal direction;
a pair of dust brushes, a first pair of side brushes, a top brush, a bottom brush, and a second pair of side brushes sequentially disposed along the conveyor, wherein each said brush is adjustably fixed relative to the conveyor so as to level a fluid treatment applied along each surface of the rectangular workpiece, wherein the fluid treatment is applied along each surface of the rectangular workpiece by way of a spray zone disposed along the conveyor between the pair of dust brushes and the first pair of side brushes, wherein the spray zone is defined, in part, by a plurality of application conduits; and
a pair of guides fore the first pair of side brushes, wherein the pair of guides are adjustable fixed relative to the conveyor so as to restrain the rectangular workpiece passing between the pair of guides, wherein a lateral gap defined between the pair of guides is approximately equal to a lateral gap defined between the first pair of side brushes.
